(19) United States
(12) Patent Application Publication
(10) Pub. No.: US 2026/0303454 A1
(43) Pub. Date: Oct. 1, 2026

(54) Converting Routing Policy Between a Structured Data Model Definition and Free-Form Programming Language

(71) Applicant: Arista Networks, Inc., Santa Clara, CA (US)

(72) Inventors: Maksim JANCENKO, Dublin (IE); Akshay GATTANI, Sunnyvale, CA (US); David CRONIN, Dublin (IE); Matthieu LORIOL, Vancouver (CA); Keon Matthew VAFAI, Belmont, CA (US); Sharad BIRMIWAL, Burnaby (CA); Rutger Antal BELTMAN, Dublin (IE); Darragh DUNNE, Dublin (IE)

(21) Appl. No.: 19/095,983

(22) Filed: Mar. 31, 2025

(51) Int. Cl. H04L 41/084; G06F 40/205; G06F 40/284

(52) U.S. Cl. CPC H04L 41/084; G06F 40/205; G06F 40/284

(57) ABSTRACT

An OpenConfig routing policy represented in one form (e.g., YANG data modeling language), is imported to a network device that implements a native implementation of routing policies represented in another form (e.g., RCF, Routing Control Function). The imported OpenConfig routing policy is converted into a native form of the routing policy, which allows the network device to take advantage of routing optimizations of the native implementation. Conversely, a native implementation of a routing policy is converted to an equivalent OpenConfig routing policy, allowing the OpenConfig routing policy to be consumed by an OpenConfig client.

### BACKGROUND

The present disclosure is directed to managing routing policies in a network device; e.g., switch, router, etc. Routing policies specify which and how routes are programmed into the routing tables of the network device and how routes are advertised. A routing policy can be defined using a structured data tree that specifies the conditions (match criteria) to evaluate a route against, and the actions to take if those conditions are met, all within a standardized format that can be managed and interpreted by the network device. For example, OpenConfig is an organization of vendors that define routing policies in terms of vendor-neutral data models. OpenConfig uses the YANG (Yet Another Next Generation) data modeling language to define its data models.

Alternatively, a routing policy can be defined using technologies such as route maps and RCFs (Routing Control Functions) to implement granular network controls. RCF is a routing policy technology that is developed and sold/licensed by Arista Networks, Inc. of Santa Clara, California. RCF is described in commonly owned U.S. Pub. No. US 2023/0038824, entitled “Efficient Runtime Evaluation Representation, External Construct Late-binding, and Updating Mechanisms For Routing Policies,” the content of which is incorporated herein by reference in its entirety for all purposes. RCF is a programming language that allows the user to define functions (referred to as policy functions) to programmatically evaluate network routes for route filtering, modify route attributes, and so on. Unlike structured data models such as YANG, RCF is a freeform programming language like any other programming language such as C, C++, Python, Java, etc.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 shows a simplified example of a network device in accordance with the present disclosure configured to convert between OpenConfig defined routing policies and RCF routing policies.

FIG. 2A shows a simplified example of a network device configured for converting OpenConfig defined routing policies into RCF routing policies.

FIG. 2B shows a simplified example of a network device configured for converting RCF routing policies into OpenConfig defined routing policies.

FIG. 3 represents a simplified routing policy example expressed as an OpenConfig data model and represented as an RCF function.

FIG. 4 is a high-level representation of format conversion operations in accordance with the present disclosure.

FIG. 5 is a high-level representation of conversion operations to convert OpenConfig formatted routing policies to RCF format in accordance with the present disclosure.

FIG. 6 is a simplified example illustrating the operations of FIG. 5.

FIG. 7 is a high-level representation of conversion operations to convert RCF formatted routing policies to OpenConfig format in accordance with the present disclosure.

FIG. 8 shows a simplified example illustrating the operations of FIG. 7.

FIG. 9 is a high-level representation of an example network device.

### DETAILED DESCRIPTION

In order to support pushing OpenConfig-based routing policies (defined using a structured data modeling language such as YANG) to a network device, a networking vendor can use tools for converting the YANG-based routing policies to a non-structured native representation that can be understood by the vendor's devices. Conversely, in order to support pushing routing policies expressed in a non-structured native representation to an OpenConfig client (network device), the vendor can use tools for converting from the device's native format to an OpenConfig data model.

The present disclosure describes converting between OpenConfig routing policies expressed in a structured representation, such as the YANG data model language, and free-form formats such as RCF functions. Structured data trees can be converted to RCF functions that can be understood by network devices that implement RCF natively allowing for an OpenConfig routing policy to be installed in a network device. Conversely, a routing policy expressed in an RCF-native network device can be converted to an equivalent data tree and pushed to an OpenConfig client.

The present disclosure will use YANG as an example of a structured data modeling language for OpenConfig routing policies. However, it will be appreciated that any suitable structured data modeling language can be used to define the data model for OpenConfig routing policies. Likewise, the present disclosure will use RCF as an example of a freeform programming language, with the understanding that the present disclosure is applicable to any suitable freeform routing tool.

YANG is a schema language that defines the structure of data (data model) to be stored or exchanged. Following is a simple example of a fragment of a YANG schema:

```
:
:
container Point {
  int x;
  int y;
}
:
:
```

An instance of the container Point, where the value of x is 10 and the value of y is 20 can be expressed in JSON (JavaScript Object Notation) data format by the text string:
{“Point”: {“x”: 10, “y”: 20}}

As another example, an instance of Point, where the value of x is 30 and the value of y is 40, that instance can be expressed in JSON data format by the text string:
{“Point”: {“x”: 30, “y”: 40}}

The present disclosure will use JSON as the data format to represent a YANG data model. It will be appreciated, however, that any suitable data format other than JSON can be used.

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

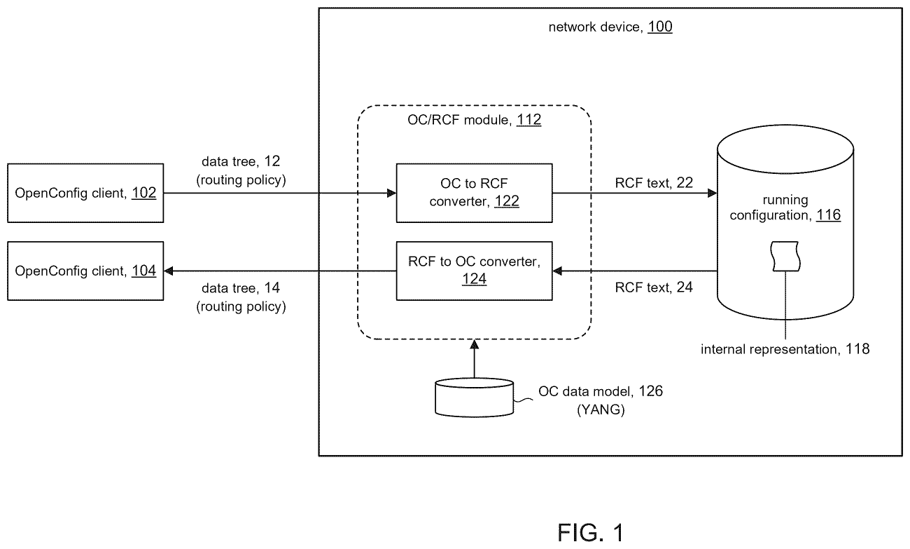

FIG. 1 is a high-level example of a network device 100 in accordance with the present disclosure. In some embodiments, network device 100 includes OpenConfig/RCF module 112 to convert between an OpenConfig data tree (routing policy) and RCF text. Module 112 comprises OpenConfig-to-RCF converter 122, RCF-to-OpenConfig converter 124. The network device 100 can include an OpenConfig data model 126 to drive the conversion process.

In accordance with the present disclosure, OpenConfig-to-RCF converter 122 can receive an OpenConfig data tree 12 (routing policy) from OpenConfig client 102 and convert the received data tree to equivalent RCF text 22 that represents the routing policy in terms of RCF programming statements. The RCF text 22 can then be compiled to produce an internal representation 118 of the routing policy that the network device 100 can execute. The internal representation 118 can be installed as part of running configuration 116 of the network device. Conversely, in accordance with the present disclosure, RCF text 24 can be generated from the running configuration 116 and provided to the RCF-to-OpenConfig converter 124 to produce an equivalent OpenConfig data tree 14. The generated data tree 14 can then be provided to an OpenConfig client 104.

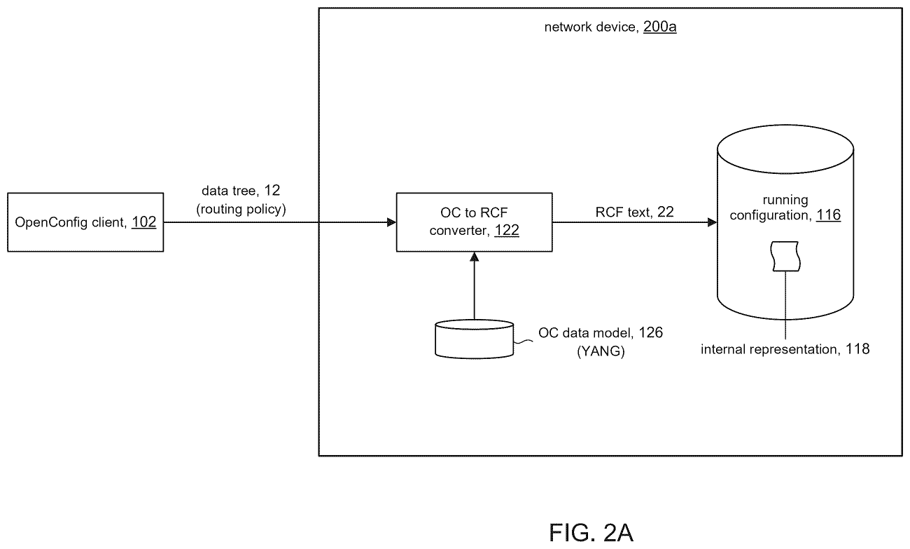

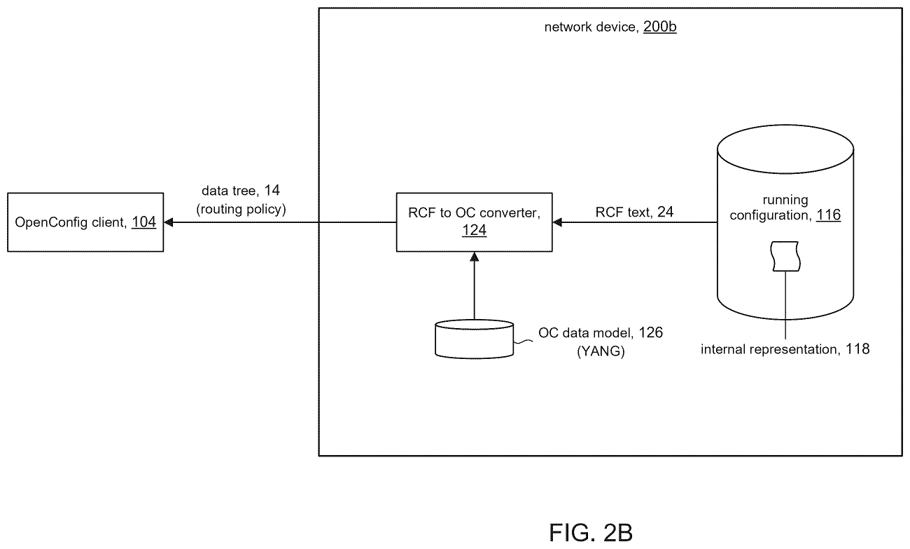

In some embodiments, a network device need not be configured with both converters 122, 124. FIG. 2A, for example, shows an example embodiment of a network device 200a that is configured with the OpenConfig-to-RCF converter 122 only. Likewise, FIG. 2B shows an example embodiment of a network device 200b that is configured with the RCF-to-OpenConfig converter 124 only.

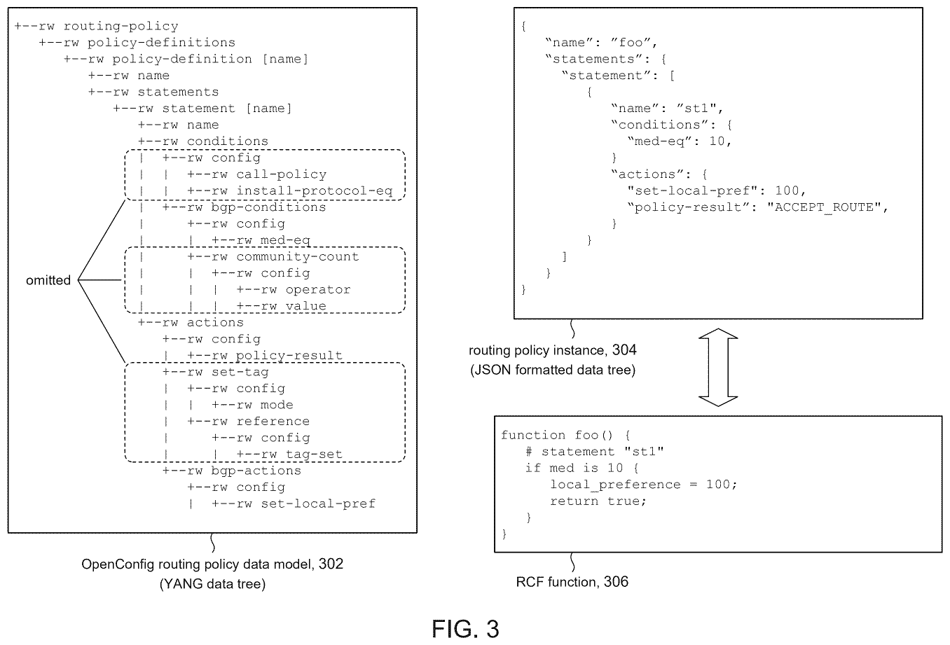

FIG. 3 shows a highly simplified example of an OpenConfig routing policy data model 302 defined using YANG (referred to as a YANG data tree). The data model informs the structure of an OpenConfig routing policy, including elements such as:
The model has a list of (one or more) routing policy definitions.
A policy definition has a name and a list of statements.
A statement comprising routing policy elements has a set of named conditions and a set of named actions.
Each of the nodes is optional; for example:
   A policy definition can have no statements.
   A statement can have some actions and no conditions.

Routing policies that conform to the routing policy data model 302 do not necessarily include every element set forth in the data model. For example, routing policy 304 omits the boxed portions of data model 302. FIG. 3 also shows an example of an RCF function 306 that is equivalent to routing policy 304.

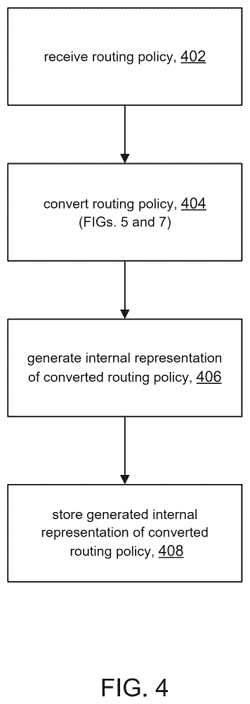

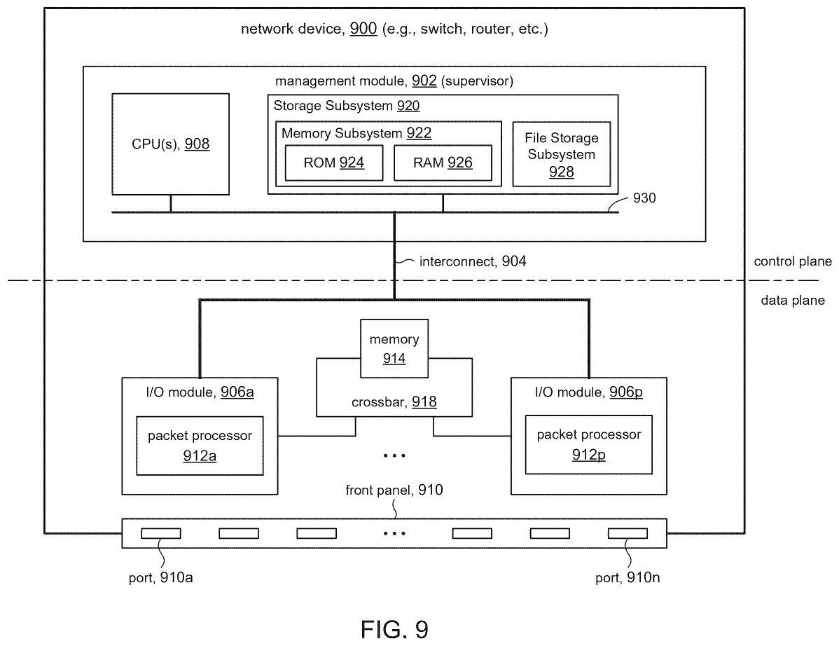

Referring to FIG. 4, the discussion will now turn to a high-level description of processing in a network device (e.g., 100, FIG. 1) for receiving and processing a routing policy in accordance with the present disclosure. The processing may be performed entirely in the control plane. In some embodiments, the network device can include one or more processing units (circuits), which when operated, can cause the network device to perform processing in accordance with FIG. 4. Processing units (circuits) in the control plane, for example, can include general CPUs that operate by way of executing computer program code stored on a non-volatile computer readable storage medium (e.g., read-only memory); e.g., CPU 908 in the control plane (FIG. 9) can be a general CPU.

The flow described below is a high-level representation of the operations and processing that can take place in a given embodiment in accordance with the present disclosure. The following operations/processing blocks are not necessarily executed in the order shown. Operations can be combined or broken out into smaller operations in various embodiments. Operations can be allocated for execution among one or more concurrently executing processes and/or threads, and so on.

At operation 402, the network device can receive a routing policy from a user, whether a human user (e.g., network administrator) or a machine user (e.g., network controller). For example, the routing policy can be defined in accordance with an OpenConfig data model, or the routing policy can be defined as an RCF function.

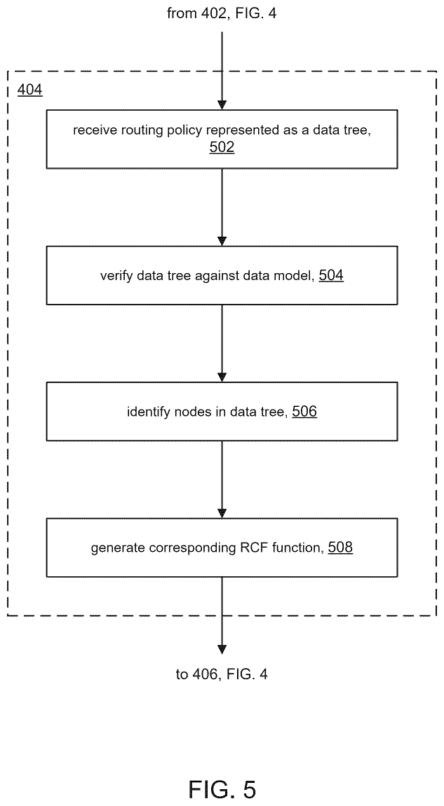

At operation 404, the network device can convert the routing policy from one representation to another. For example, if the network device receives a routing policy defined in accordance with an OpenConfig data model, the network device can convert the routing policy to an RCF function. Alternatively, if the routing policy is defined as an RCF function, the network device can convert the RCF function to produce a routing policy in accordance with an OpenConfig data model. Details of this operation are discussed further below in connection with FIGS. 5-8.

At operation 406, the network device can generate an internal representation of the converted policy. For example, if the received routing policy is converted to an RCF function, the internal representation can be generated by compiling the RCF function, which can then be executed by the network device. If the received routing policy is converted to an OpenConfig data model, the internal representation can be generated by an OpenConfig interpreter that understands the routing policy data model.

At operation 408, the network device can store the generated internal representation of the converted routing policy. In some embodiments, for example, the internal representation can be programmed in a routing information base (e.g., routing tables) of the network device. Processing can be deemed complete.

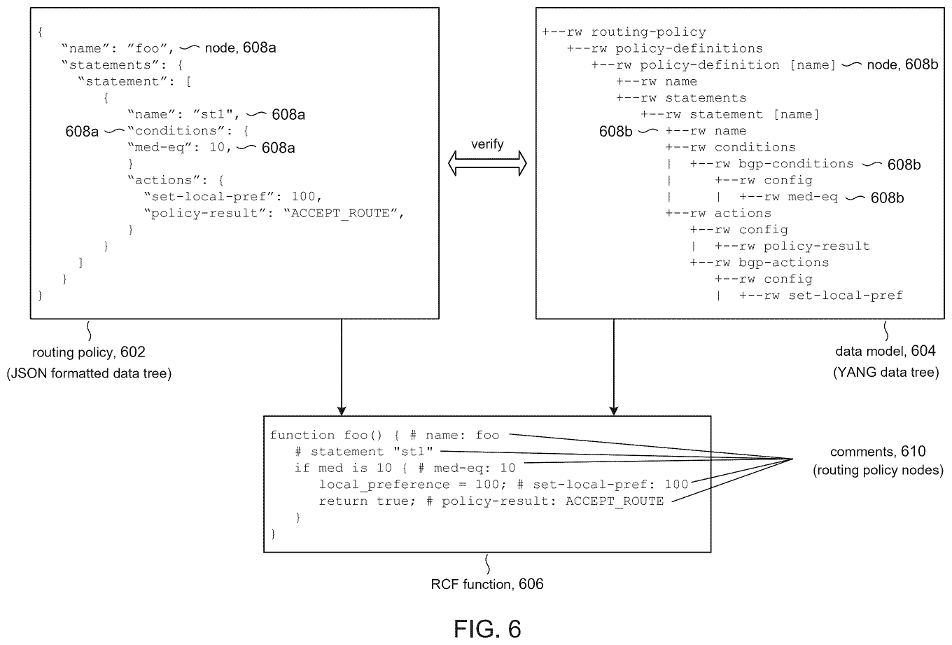

Referring to FIGS. 5 and 6, the discussion will now turn to a high-level description of processing in a network device (e.g., OpenConfig-to-RCF converter 122, FIG. 1) for converting an OpenConfig compliant routing policy to an equivalent RCF function. For example, the operations of FIG. 5 can be invoked from operation 402, FIG. 4. In some embodiments, the network device can include one or more processing units (circuits), which when operated, can cause the network device to perform processing in accordance with FIG. 5. Processing units (circuits) in the control plane, for example, can include general CPUs that operate by way of executing computer program code stored on a non-volatile computer readable storage medium (e.g., read-only memory); e.g., CPU 908 in the control plane (FIG. 9) can be a general CPU.

The flow described below is a high-level representation of the operations and processing that can take place in a given embodiment in accordance with the present disclosure. The following operations/processing blocks are not necessarily executed in the order shown. Operations can be combined or broken out into smaller operations in various embodiments. Operations can be allocated for execution among one or more concurrently executing processes and/or threads, and so on.

At operation 502, the network device can receive a routing policy, expressed as a data tree, with which to configure the network device. The routing policy can be expressed as a JSON data tree with the understanding that the routing policy can be encoded in any suitable data format (e.g., YAML, Yet Another Markup Language). FIG. 6, for instance, represents an example of a routing policy 602 expressed in JSON format.

At operation 504, the network device can verify the received data tree against a data model of the routing policy (e.g., expressed using YANG). In some embodiments, the data model can already be stored (preloaded) in the network device.

At operation 506, the network device can scan the data tree to identify nodes in the data tree that correspond to RCF program elements (keywords, statements, etc.) of an RCF function. In some embodiments, for example, the network device can store a mapping between RCF program elements and data tree node names. The network device can “walk” the data tree to identify RCF-related nodes in the data tree. Referring to FIG. 6, for instance, shows examples of nodes 608a in the data tree of routing policy 602.

At operation 508, the network device can generate an equivalent RCF function. For example, the network device can generate RCF program statements corresponding to each identified node in the data tree. The received OpenConfig routing policy can be scanned to extract attributes associated with the statements. Referring to nodes 608a, 608b in the example routing policy 602 and data model 604 in FIG. 6, for instance, the “policy-definition/name” node in the data model 604 maps to an RCF function name. The name of the generated RCF function can be based on the ‘name’ attribute in the routing policy 602 (in this example, “foo”). Likewise, the “bgp-conditions” node in the data model 604 maps to an RCF “if” statement, and the attributes of the “if” statement can be obtained from the routing policy 602 (more specifically, the contents of the bgp-conditions node map to the contents of the “if” statement), and so on. FIG. 6 shows an example of a resulting equivalent RCF function 606.

In some embodiments, YANG node names from the data tree can be embedded among the program statements in RCF function 606 as comments 610. The embedded comments 610 can facilitate a subsequent conversion of an RCF function back to an OpenConfig routing policy. For example, the “# name: foo” comment in the RCF function 606 references a node 608a in the routing policy 602 and identifies the function as originating from OpenConfig. The “#statement” comment identifies the data tree node 608a that the “if” program block in the RCF function corresponds to, and so on.

The conversion operation in FIG. 5 can be deemed complete and processing can continue with operation 406 in FIG. 4.

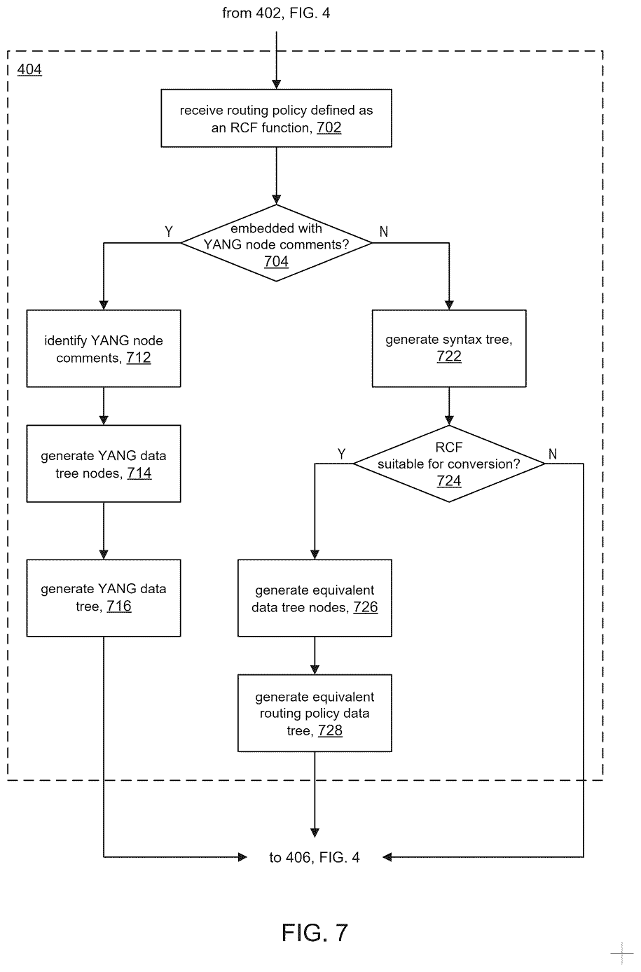

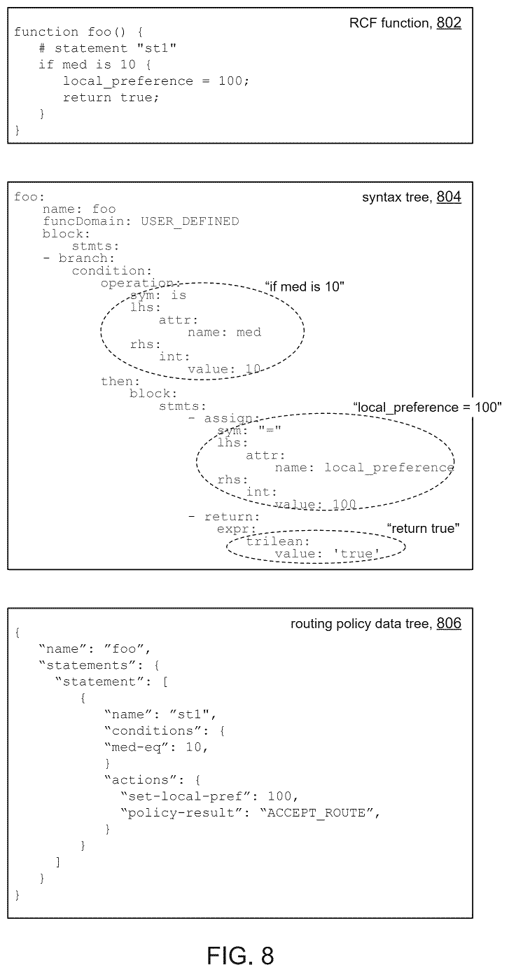

Referring to FIGS. 7 and 8, the discussion will now turn to a high-level description of processing in a network device (e.g., RCF-to-OpenConfig converter 124, FIG. 1) for converting a routing policy defined as an RCF function to an equivalent OpenConfig compliant routing policy. For example, the operations of FIG. 7 can be invoked from operation 402, FIG. 4. In some embodiments, the network device can include one or more processing units (circuits), which when operated, can cause the network device to perform processing in accordance with FIG. 7. Processing units (circuits) in the control plane, for example, can include general CPUs that operate by way of executing computer program code stored on a non-volatile computer readable storage medium (e.g., read-only memory); e.g., CPU 908 in the control plane (FIG. 9) can be a general CPU.

The flow described below is a high-level representation of the operations and processing that can take place in a given embodiment in accordance with the present disclosure. The following operations/processing blocks are not necessarily executed in the order shown. Operations can be combined or broken out into smaller operations in various embodiments. Operations can be allocated for execution among one or more concurrently executing processes and/or threads, and so on.

At operation 702, the network device can receive a routing policy defined as an RCF function. FIG. 8, for instance, shows an example of an RCF function 802.

At decision point 704, if the received RCF function is embedded with comments that reference nodes in a data model, then processing can continue at operation 712; otherwise, processing can continue at operation 722. For discussion purposes, we can assume without loss of generality, that the data model is expressed as a YANG data tree, and the comments reference nodes in the YANG data tree (YANG node comments). The discussion will first consider an RCF function commented with YANG node comments followed by a discussion of an RCF function without such comments.

RCF Function with YANG Node Comments (e.g., RCF Function 606, FIG. 6)

The received RCF function can be embedded with YANG node comments from a previous conversion of an OpenConfig compliant routing policy (data tree) to the RCF function; see for example, comments 610 in RCF function 606 in FIG. 6. The presence of YANG node comments can facilitate the conversion back from RCF to a routing policy data tree by ignoring the RCF statements.

At operation 712, the network device can scan the received RCF function to identify the YANG node comments. RCF function 606 in FIG. 6, for instance, shows examples of data tree comments 610.

At operation 714, the network device can generate intermediate YANG data tree nodes from the identified data tree comments.

At operation 716, the network device can stitch together intermediate YANG data tree nodes to produce an equivalent YANG data tree routing policy (e.g., 604, FIG. 6).

The conversion operation in FIG. 7 can be deemed complete and processing can continue with operation 406 in FIG. 4.

RCF Function without YANG Node Comments (e.g., Routing Policy 802, FIG. 8)

At operation 722, the network device can generate a syntax tree from the received RCF function. In some embodiments, for example, the syntax tree can be generated using known compiler operations such as lexical analysis and parsing. For example, lexical analysis of the program statements of the RCF function generates a tokenized representation of the program statements. The syntax tree is generated by parsing the tokens. The resulting syntax tree is a structured representation of the freeform RCF function. FIG. 8, for instance, shows an example of a syntax tree 804 expressed in YAML (Yet Another Markup Language) that corresponds to RCF function 802.

At decision point 724, if the received RCF function is not suitable for conversion, then the RCF function will not be converted. For example, YANG does not support arbitrary nesting of conditions or actions, whereas RCF is a more flexible and expressive policy framework. RCF allows a user to construct functions where condition blocks can be nested, actions can be placed in arbitrary locations, and other functions can be invoked in place of a condition or action. Consider the following generalized RCF function example:

```
function POLICY_DEFINITION_NAME( ) {
  if <condition-a> and <condition-b> {
    <action-a>;
    <action-b>;
    if not <condition-c> {
      <action-c>;
    }
  } else if <condition-d> {
    if <condition-e> {
      <action-e>;
    }
    <action-d>;
  }
}
```

The example above illustrates examples of nested “if” statements at lines 5 and 9. The YANG data modeling language does not support such nesting, and so the example RCF function would be deemed not suitable for conversion.

If the received RCF function is not suitable for conversion, the conversion can be deemed complete and processing can continue at operation 406 in FIG. 4. In some embodiments, an error can be logged. If the received RCF function is suitable for conversion, then processing can proceed to operation 726.

At operation 726, the network device can identify individual data tree nodes from the syntax tree (e.g., 804).

At operation 728, the network device can stitch together the identified individual data tree nodes to produce an equivalent routing policy data tree (e.g., 604, FIG. 6). FIG. 8, for example, shows an example routing policy data tree 806 that can be generated from syntax tree 804.

The conversion operation in FIG. 7 can be deemed complete and processing can continue with operation 406 in FIG. 4.

FIG. 9 is a schematic representation of a network device 900 (e.g., a router, switch, firewall, and the like) that can be adapted in accordance with the present disclosure. In some embodiments, for example, network device 900 can include one or more management modules 902, one or more I/O modules (switches, switch chips) 906a-906p, and a front panel 910 of I/O ports (physical interfaces, I/Fs) 910a-910n. Management module 902 can constitute the control plane of network device 900 (also referred to as the control layer or simply the central processing unit, CPU), and can include CPU(s) 908 for managing and controlling operation of network device 900 in accordance with the present disclosure. CPU(s) 908 can be a general-purpose processor, such as an Intel®/AMD® x86, ARM® microprocessor and the like, that operates under the control of software stored in a memory device/chips such as read-only memory (ROM) 924 or random-access memory (RAM) 926. The control plane provides services that include traffic management functions such as routing, security, load balancing, analysis, and the like.

CPU(s) 908 can communicate with storage subsystem 920 via bus subsystem 930. Other subsystems, such as a network interface subsystem (not shown in FIG. 9), may be on bus subsystem 930. Storage subsystem 920 can include memory subsystem 922 and file/disk storage subsystem 928. Memory subsystem 922 and file/disk storage subsystem 928 represent examples of non-transitory computer-readable storage devices that can store program code and/or data, which when executed by CPU(s) 908, can cause CPU(s) 908 to perform operations in accordance with embodiments of the present disclosure.

Memory subsystem 922 can include a number of memories such as main RAM 926 (e.g., static RAM, dynamic RAM, etc.) for storage of instructions and data during program execution, and ROM (read-only memory) 924 on which fixed instructions and data can be stored. File storage subsystem 928 can provide persistent (i.e., non-volatile) storage for program and data files, and can include storage technologies such as solid-state drive and/or other types of storage media known in the art.

CPU(s) 908 can run a network operating system stored in storage subsystem 920. A network operating system is a specialized operating system for network device 900. For example, the network operating system can be the Arista EOS® operating system, which is a fully programmable and highly modular, Linux-based network operating system developed and sold/licensed by Arista Networks, Inc. of Santa Clara, California. It is understood that other network operating systems may be used.

Bus subsystem 930 can provide a mechanism for the various components and subsystems of management module 902 to communicate with each other as intended. Although bus subsystem 930 is shown schematically as a single bus, alternative embodiments of the bus subsystem can utilize multiple buses.

The one or more I/O modules 906a-906p can be collectively referred to as the data plane of network device 900 (also referred to as the data layer, forwarding plane, etc.). Interconnect 904 represents interconnections between modules in the control plane and modules in the data plane. Interconnect 904 can be any suitable bus architecture such as Peripheral Component Interconnect Express (PCIe), System Management Bus (SMBus), Inter-Integrated Circuit (I²C), etc.

I/O modules 906a-906p can include respective packet processing hardware comprising packet processors 912a-912p (collectively 912) to provide packet processing and forwarding capability. Each I/O module 906a-906p can be further configured to communicate over one or more ports 910a-910n on the front panel 910 to receive and forward network traffic. Packet processors 912 can comprise hardware (circuitry), including for example, data processing hardware such as an application specific integrated circuit (ASIC), field programmable gate array (FPGA), processing unit, and the like, which can be configured to operate in accordance with the present disclosure. Packet processors 912 can include forwarding lookup hardware such as, for example, but not limited to content addressable memory such as ternary CAMs (TCAMs) and auxiliary memory such as static RAM (SRAM).

Memory hardware 914 can include buffers used for queueing packets. I/O modules 906a-906p can access memory hardware 914 via crossbar 918. It is noted that in other embodiments, the memory hardware 914 can be incorporated into each I/O module. The forwarding hardware in conjunction with the lookup hardware can provide wire speed decisions on how to process ingress packets and outgoing packets for egress. In accordance with some embodiments, some aspects of the present disclosure can be performed wholly within the data plane.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

1. A method for configuring a network device, the method comprising:
receiving a routing policy that conforms to a routing policy data model, wherein the data model is expressed in a data modeling language, wherein the routing policy is represented as a data tree;
converting the received routing policy to one or more RCF (routing control function) element, including:
validating the received routing policy against the routing policy data model;
identifying nodes in the data tree that correspond to an RCF element; and
for each node identified in the data tree, generating a corresponding set of one or more RCF elements based on the identified node; and
configuring the network device according to the routing policy, including compiling the generated RCF elements and storing output produced from compiling the generated RCF elements.

2. The method of claim 1, wherein the received routing policy is expressed in JSON (JavaScript Object Notation) format.

3. The method of claim 1, further comprising, for each node identified in the data tree, embedding a representation of the node as an inline comment associated with the one or more RCF elements corresponding to the node.

4. The method of claim 1, wherein the routing policy data model is an OpenConfig (Open Configuration) defined routing policy.

5. The method of claim 1, wherein the data modeling language is YANG (Yet Another Next Generation) modeling language.

6. The method of claim 1, wherein the routing policy elements include conditional elements and actions elements.

7. The method of claim 1, wherein the routing policy element sets an attribute of a route.

8. The method of claim 1, wherein the received routing policy is obtained from an OpenConfig network device.

9. A method for configuring a network device, the method comprising:
receiving a routing policy defined as an RCF function, the RCF function comprising a plurality of program statements, wherein the plurality of program statements represent a policy for processing routes in the network device;
generating a routing policy data tree that represents the plurality of program statements, wherein generating the routing policy data tree includes:
generating a syntax tree representation of the plurality of program statements, the syntax tree comprising a plurality of nodes;
identifying one or more nodes in the generated syntax tree;
generating corresponding data tree nodes from the one or more nodes identified in the syntax tree; and
generating the routing policy data tree from the generated data tree nodes; and
installing the generated routing policy data tree in the network device to configure the network device to process routes in accordance with the received routing policy.

10. The method of claim 9, wherein the generated routing policy data tree conforms to an OpenConfig data model.

11. The method of claim 10, wherein the OpenConfig data model is expressed using YANG data modeling language.

12. The method of claim 9, wherein generating the syntax tree representation includes performing a lexical analysis of the plurality of program statements to generate a tokenized representation of the plurality of program statements and parsing the tokenized representation of the plurality of program statements to generate the syntax tree representation.

13. The method of claim 9, wherein the RCF function is generated from a previous routing policy data tree, wherein the RCF function includes representations of nodes of the previous routing policy data tree that are expressed as inline comments among the plurality of program statements in the RCF function, the method further comprising verifying the generated data tree nodes in the generated routing policy data tree using the nodes of the previous routing policy data tree.

14. The method of claim 9, wherein the plurality of program statements are obtained from another network device.

15. A network device comprising:
one or more computer processors; and
a computer-readable storage device comprising instructions that control the one or more computer processors to:
receive a routing policy that conforms to a routing policy data model, wherein the data model is expressed in a data modeling language, wherein the routing policy is represented as a data tree;
convert the received routing policy to one or more RCF (routing control function) statements, including:
validating the received routing policy against the routing policy data model;
identifying nodes in the data tree that correspond to an RCF statement; and
for each node identified in the data tree, generating a corresponding set of one or more RCF statements based on the identified node; and
configure the network device according to the routing policy, including compiling the generated RCF statements and storing output produced from compiling the generated RCF statements.

16. The network device of claim 15, wherein the received routing policy is expressed in JSON (JavaScript Object Notation) format.

17. The network device of claim 15, wherein the computer-readable storage device further comprises instructions that control the one or more computer processors to embed a representation of each identified node as an inline comment associated with the one or more RCF statements corresponding to the node.

18. The network device of claim 15, wherein the routing policy data model is an OpenConfig (Open Configuration) defined routing policy.

19. The network device of claim 15, wherein the data modeling language is YANG (Yet Another Next Generation) modeling language.

20. The network device of claim 15, wherein the received routing policy is obtained from an OpenConfig network device.
